(19) United States
(12) Patent Application Publication
(10) Pub. No.: US 2020/0147850 A1
(43) Pub. Date: May 14, 2020

(54) CASTING TOOL, FOR EXAMPLE CORE SHOOTING TOOL OR PERMANENT MOULD, AND CORRESPONDING CASTING METHOD

(71) Applicant: Meissner AG Modell- und Werkzeugfabrik, Biedenkopf-Wallau (DE)

(72) Inventor: Ulrich FLÖTZINGER, Bad Laasphe (DE)

(21) Appl. No.: 16/668,404

(22) Filed: Oct. 30, 2019

(30) Foreign Application Priority Data
Nov. 14, 2018 (DE) 102018128605.8

(51) Int. Cl. B29C 45/78; B29C 45/34

(52) U.S. Cl. CPC B29C 45/78; B29C 45/34; B29C 2945/7604; B29C 2945/76531; B29C 2945/76006; B29C 2945/76254; B29C 2945/76127

(57) ABSTRACT

A casting tool, for example a core shooting tool or a permanent mould, having an upper tool part and a lower tool part, which on opposite sides each have at least one engraving formed as a shell engraving and which form a mould cavity, characterized in that the shell engraving on an outer side facing away from the mould cavity comprises at least one physical sensor which is configured to measure a physical quantity with respect to a material accommodated in the mould cavity. Furthermore, a corresponding casting method is described.

### CROSS-REFERENCE TO RELATED APPLICATIONS

This application claims the benefit and priority of German Application No. 102018128605.8 filed Nov. 14, 2018. The entire disclosure of the above application is incorporated herein by reference.

### FIELD

The invention relates to a casting tool having an upper tool part and a lower tool part, which on opposite sides each have at least one engraving formed as a shell engraving and which form a mould cavity. Such a casting tool is known from DE 1 208 505 A1.

### BACKGROUND

Such casting tools can, for example, be used as core shooting tools for the production of casting cores from sand, salt or other moulding materials. These tools can also be permanent moulds in a permanent mould casting method, tools for die casting as well as moulds for plastic injection moulding, e.g. for the production of a glass mat reinforced thermoplastic (GMT), for the extrusion of sheet moulding compounds (SMC) or for long fibre injection (LFI). For example, so-called core shooting machines are used for core shooting, which usually have a two-part solid core box. The core box delimits a mould cavity which represents the outer shape of the core to be produced. For core shooting, a mould base material mixed with binder is shot into the core box in the core shooting machine at a shooting pressure of, for example, 2 to 6 bar at a defined working temperature. After the core has hardened, it can be inserted into a casting mould. After casting, the moulding material of which the core consists is removed through openings in the casting construction, thereby destroying the core.

In the permanent mould casting method, the melt is poured into the permanent mould via an upper insert and its cavity is filled due to gravity only. To avoid volume deficits, so-called shrink holes, certain parts of the casting are thermally insulated to delay solidification or cooled by cooling pins to accelerate solidification.

DE 10 2011 111 583 A1 further describes a temperature-controlled tool for shaping workpieces, whereby the shaping contour of the tool is designed as a shell with a heat-conducting structure on a side facing away from the mould cavity made of an open-pored, porous material through which a temperature control medium flows. Thereby an improved temperability of the tool is to be achieved when shaping workpieces. Another temperature-controlled tool with a shell design is described in DE 10 2014 223 922 A1.

The disadvantage of the temperature-controlled shell tools known from the state of the art is that they are not suitable for responding to process fluctuations in the tool, such as pressure or temperature fluctuations, caused by the material being shot during the moulding process, for example during the core shooting process, in order to produce reproducible moulding results, in particular mouldings such as cores with homogeneous material properties.

It is therefore the task of the invention to further develop a casting tool and a corresponding casting method of the type described above in such a way that they provide reproducible process results and allow the individual adaptation of the moulded body or core properties, in particular the material density.

The problem is solved by a casting tool having the features of claim 1. Claim 13 relates to a corresponding casting method.

### SUMMARY

This section provides a general summary of the disclosure, and is not a comprehensive disclosure of its full scope or all of its features.

Accordingly, it is provided that the shell engraving on an outer side facing away from the mould cavity comprises at least one physical sensor which is configured to measure a physical quantity with respect to a material accommodated in the mould cavity. The physical quantity can be, for example, a temperature and/or a specific material density. The sensor may not be in direct contact with the material accommodated in the mould cavity, but may measure the physical quantity through the shell engraving. In order, for example, to keep the measurement delay short when measuring the temperature through the wall of the shell engraving, the thickness of the wall can be reduced to a minimum necessary from a mechanical point of view. For example, the shell engraving can have a wall thickness at least in the area of a measuring field of the sensor between 0.5 and 15 mm, preferably between 0.5 and 10 mm and especially preferably between 0.5 and 3 mm. If the shell is this thin, the temperature of the shot material can be inferred from the temperature of the shell without delay in order to monitor correct mould filing.

For example, a temperature sensor attached to the outer side of the engraving can detect the inflow of the moulding material into a core shooting tool. The cold moulding material quickly cools the preheated thin shell tool, resulting in an easily measurable sensor signal. Likewise, an ultrasonic sensor attached to the outer side of the engraving can be used to measure the density of the cavity filling through the shell due to the small wall thickness of the shell. For example, it can be detected whether mould material is in the cavity of the engraving or not.

Generally, the casting tool is not limited to any specific embodiment and may be a core shooting tool or a permanent mould by way of example.

By using a temperature sensor which is thermally coupled directly to the shell engraving as well as a heating element which is also thermally coupled to the shell engraving, it is possible to react to temperature fluctuations during the shooting by adjusting the heating power of the heating element in-situ as required. This is made possible in particular by the fact that the engraving is designed as shell engraving and therefore has a low heat capacity, so that temperature fluctuations can be detected quickly and heating power can also be transferred to the mould cavity without delay.

The upper and lower part of the tool can be made of a metal due to good thermally conductive properties, at least in the area of shell engraving, such as an alloyed, high-alloyed or unalloyed steel, an aluminium alloy, a copper alloy such as bronze or brass, or a zinc alloy such as zamak. The upper and lower parts of the tool can also be made of a thermally conductive plastic, at least in the area of the shell engraving. Particularly advantageous are tools with a filling, which are equipped with a graphite filling, for example, and thus have a particularly high thermal conductivity. Ceramic materials such as aluminium oxide, oxide ceramics, nitrite ceramics and carbides are also suitable for producing the upper and/or lower tool parts, as are silicate ceramics, mullite and magnesium oxide ceramics. Carbon and graphite are also suitable as tool materials.

The at least one physical sensor is not limited to any particular embodiment and may have a single sensor for measuring a single physical quantity or several sensors for measuring different physical quantities. The physical sensor may, for example, comprise a temperature sensor thermally coupled to the shell engraving, wherein the casting tool may have at least one heating element thermally coupled to the shell engraving and a control unit which is configured to adjust a heating power of the heating element depending on a measurement signal from the temperature sensor in order to achieve a uniform casting density.

Alternatively or additionally, the physical sensor can comprise a density sensor mechanically coupled to the shell engraving for determining the density of a material shot into the mould cavity, wherein the control unit is configured to adjust the heating power of the heating element depending on a measurement signal from the density sensor.

A suitable density sensor, for example, is an ultrasonic sensor with or without an integrated ultrasonic source. The sound penetrating through the wall of the shell engraving into the mould cavity is reflected depending on the density of the material in the mould cavity, so that the signal of the ultrasonic sensor can be used for evaluating the density.

A plate of the upper or lower tool part may comprise the shell engraving, the plate having a thickness less than a depth of the shell engraving parallel to the thickness. Thus it may be provided that the plate on an outer side facing away from the mould cavity has a raised contour which corresponds at least in sections to a contour of the shell engraving and is preferably a negative of the contour of the shell engraving. The shell engraving can be produced by means of a casting method. If necessary, the cast shell engraving can be machined.

A multi-channel mould venting system for venting the mould cavity can be connected to the shell engraving at different positions of the mould cavity. The mould venting system may comprise one or more air pressure sensors which measure a respective venting pressure of the mould cavity at the different positions.

The mould venting system may also include a valve block with multiple independently controllable valves, each valve being fluidically connected to one of the other positions via an air line. The control unit may be configured to control an opening degree of at least one of the valves, depending on at least one measurement signal of the air pressure sensors.

A multi-channel mould ventilation system can be connected to the shell engraving to selectively apply pressure to the mould cavity at different positions of the mould cavity. The mould ventilation system may include a valve block with multiple independently controllable valves, each valve fluidically connected to one of the other positions via an air line. By the selective application of air pressure, the mould ventilation system can be used by selectively applying air pressure to push the moulded part out of the mould after the casting material has been shot in and, if necessary, the casting tool has been cooled. For example, uniform application of air pressure can be used to ensure that the core does not jam when it is pushed out of the mould when shooting the core, thereby impairing its geometry.

The at least one heating element can have a heating coil mounted in a heat-conducting jacket or a radiant heater, such as an IR radiator. The IR radiator can be positioned in front of and facing the shell engraving spaced apart from the outer side via an air gap.

The at least one heating element can be thermally coupled to a raised contour of the plate, which corresponds at least in sections to a contour of the shell engraving, e.g. be in heat-conducting contact. By adapting the geometry of the heating element to a contour or a contour section of the shell engraving, heat can be selectively transferred locally into the mould cavity. If the heating element has a controllable heating power, the heat flow into the mould cavity can also be controlled. The heating element, for example, can have a geometry that reproduces a raised contour of the plate on its outer side facing away from the shell engraving.

The casting tool may also have an ejection system configured to deform the shell engraving between an initial geometry and an ejection geometry, in particular to elastically deform it. For this purpose, the ejection system can, for example, engage the edge area of the upper and/or lower tool part and preload it mechanically. In order to control the deformation during preloading of the upper and/or lower tool part, it may be provided that the plate, preferably the shell engraving of the plate, consists in sections of a first material and in sections of a second material, the two materials having different moduli of elasticity.

The shell engraving can have a surface coating on an inner side facing the mould cavity which reduces the adhesion between the shell engraving and the material accommodated in the mould cavity. By means of the coating, for example, it is possible to prevent the core from sticking to the shell engraving and thus to avoid large forces on the engraving during ejection, which could damage thin-walled engravings in particular.

According to another aspect, a casting method is described, comprising the steps:

providing a casting tool of the type described above and shooting a flowable and curable material, such as a binder-added mould base material, into the mould cavity under a shooting pressure, wherein the shell engraving is heated with a heating element; and

measuring a physical quantity of the material shooting into the mould cavity, such as a temperature of the shell engraving when shooting, and adjusting a heating power of the heating element, depending on the measured temperature.

When shooting, a density of the shot material can be measured and, depending on the measured density, the heating power of the heating element can be adjusted.

When shooting, the mould cavity can be vented at different positions by means of a multi-channel mould venting system and a respective venting pressure of the mould cavity can be measured at the different positions by air pressure sensor.

Depending on at least one measurement signal from the air pressure sensors, an opening degree of at least one valve that is fluidically connected to one of the positions via an air line can be controlled. The opening degree of the valve can be adjusted in such a way that a desired venting pressure of the mould cavity is achieved at the position of the respective air pressure sensor.

After shooting and cooling the casting tool, a moulded casting arranged and formed in the mould cavity can be ejected from the mould cavity by means of a mould ventilation system, for which purpose the mould ventilation system applies an air pressure to the casting via a valve block with multiple independently controllable valves, each of which is fluidically connected via an air line to one other position of the mould cavity.

### DRAWING

The drawing described herein is for illustrative purposes only of selected embodiments and not all possible implementations, and are not intended to limit the scope of the present disclosure.

FIG. 1 shows an exploded view of an exemplary embodiment of a casting tool according to the invention, which is designed as a core shooting tool.

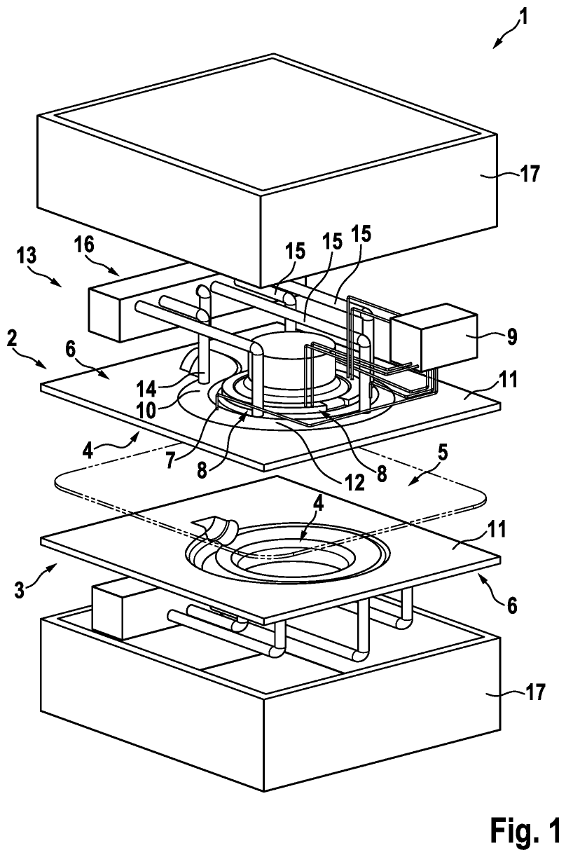

### DETAILED DESCRIPTION

Example embodiments will now be described more fully with reference to the accompanying drawing.

The core shooting tool 1 has a upper tool part 2 and a lower tool part 3, which are accommodated in a two-part core box 17 and each have a shell engraving 4 on opposite sides. For the core shooting tool 1 shown in an exploded view, the shell engravings 4 of the upper tool part 2 and the lower tool part 3 form a mould cavity 5 in a joined state, said mould cavity 5 being formed between the upper tool part 2 and the lower tool part 3 and representing the core mould. The upper shell engraving 4 depicted in the figure has several temperature sensors 7 thermally contacted with the shell engraving 4 on an outer side 6 facing away from the mould cavity 5 and two heating elements 8 thermally contacted with the shell engraving 4. A control unit 9 is configured to adjust the heating power of the heating elements 8 depending on a measurement signal from the temperature sensors 7, e.g., in such a way that a constant process temperature is maintained, or in such a way, that a local temperature increase is achieved, which locally increases the flowability of the shot material.

The core shooting tool further has a core density sensor 10, whose measurement signal is also evaluated by the control unit 9 and used to adjust the heating power of the heating element 8 as required. A suitable core density sensor 10, for example, is an ultrasonic sensor.

The upper tool part 2 and the lower tool part 3 are designed as plates 11, which have the shell engraving 4. The thickness of the plate 11 is considerably less than a depth of the shell engraving 4, which results in a raised contour 12 being formed on the outer side 6 facing away from the mould cavity 5, which is negative to a contour of the shell engraving 4 delimiting the mould cavity.

The core shooting tool 1 also has a mould venting system 13, which is connected to the plates 11, especially in the area of the shell engraving 4. The mould venting system serves to vent the mould cavity 5 in a defined manner during the shooting of the mould base material mixed with the binder, so that a uniform filling of the mould cavity 5 with the mould base material is achieved and thus the density of the core is as homogeneous as possible. The mould venting system 13 has several air pressure sensors 14 which measure the respective venting pressure of the mould cavity 5 at the different positions of the mould cavity.

The mould venting system also has a valve block 16 with several independently controllable valves. Each of the valves is fluidically connected to one of the other positions of the mould cavity 5 via a separate air line 15. For this purpose, the shell engraving 4 can have through holes to which the air lines 15 are connected. The control unit 9 can be configured to control an opening degree of at least one of the valves depending on at least one measurement signal of the air pressure sensors 14, e.g., with the proviso that the mould cavity 5 is filled as uniformly as possible with the mould base material during shooting.

The mould venting system 13 may also function as a mould ventilation system for selectively applying air pressure to mould cavity 5 at different positions in mould cavity 5. For example, mould ventilation can be used to eject the core from the mould cavity 5 after the mould base material has been shot into and solidified, that is after the core has formed in the mould cavity 5.

Due to the shell design, an efficient core shooting tool is realized since the heat capacity of the core shooting tool is reduced compared to conventional tools. Conversely, the lower heat capacity of the shell core tool also means that heat can be transferred from outside the core shooting tool into the cavity of the core shooting tool without a long time delay and with comparatively low heating power. By using a heater it is possible to vary the core properties. With the help of temperature and core density sensors a continuous quality assurance can be realized in-situ.

The features of the invention disclosed in the above description, in the drawings and in the claims may be essential to the realisation of the invention, either individually or in any combination.

Further areas of applicability will become apparent from the description provided herein. The description and specific examples in this summary are intended for purposes of illustration only and are not intended to limit the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A casting tool comprising an upper tool part and a lower tool part, which on opposite sides each have at least one engraving formed as a shell engraving and which form a mould cavity, wherein the shell engraving on an outer side facing away from the mould cavity includes at least one physical sensor which is configured to measure a physical quantity with respect to a material accommodated in the mould cavity.

2. The casting tool according to claim 1, in which the physical sensor comprises a temperature sensor thermally coupled to the shell engraving, wherein the casting tool has at least one heating element thermally coupled to the shell engraving and a control unit which is configured to adjust a heating power of the heating element depending on a measurement signal from the temperature sensor.

3. The casting tool according to claim 1, in which the physical sensor comprises a density sensor mechanically coupled to the shell engraving for determining the density of a material shot into the mould cavity, wherein the control unit is configured to adjust the heating power of the heating element depending on a measurement signal from the density sensor.

4. The casting tool according to claim 1, in which the shell engraving has a wall thickness at least in the area of a measuring field of the sensor between 0.5 and 15 mm, preferably between 0.5 and 10 mm and especially preferably between 0.5 and 3 mm.

5. The casting tool according to claim 1, in which a multi-channel mould venting system for venting the mould cavity is connected to the shell engraving at different positions, wherein the mould venting system may comprise multiple air pressure sensors which measure a respective venting pressure of the mould cavity at the different positions.

6. The casting tool according claim 5, in which the mould venting system also includes a valve block with multiple independently controllable valves, each valve being fluidically connected to one of the other positions via an air line, wherein the control unit is configured to control an opening degree of at least one of the valves, depending on at least one measurement signal of the air pressure sensors.

7. The casting tool according to claim 5, in which a multi-channel mould ventilation system is connected to the shell engraving to selectively apply pressure to the mould cavity at different positions of the mould cavity, wherein the mould ventilation system includes a valve block with multiple independently controllable valves and each valve is fluidically connected to one of the other positions via an air line.

8. The casting tool according to claim 1, in which the at least one heating element is thermally coupled to a raised contour of the plate, which corresponds at least in sections to a contour of the shell engraving.

9. The casting tool according to claim 8, in which the heating element has a geometry that reproduces a raised contour of the plate on its side opposite the shell engraving.

10. The casting tool according to claim 1, the casting tool having an ejection system configured to deform the shell engraving between an initial geometry and an ejection geometry.

11. The casting tool according to claim 8 in which the plate, preferably the shell engraving of the plate, consists in sections of a first material and in sections of a second material, the two materials having different moduli of elasticity.

12. The casting tool according to claim 1, in which the shell engraving has a surface coating on an inner side facing the mould cavity which reduces the adhesion between the shell engraving and the material accommodated in the mould cavity.

13. The casting tool according to claim 1, in which the casting tool is a core shooting tool or a permanent mould.

14. A casting method, comprising:
providing a casting tool according to claim 1 and shooting a flowable and curable material, such as a binder-added mould base material, into the mould cavity under a shooting pressure, wherein the shell engraving is heated with a heating element; and
measuring a physical quantity of the material shooting into the mould cavity, such as a temperature of the shell engraving when shooting, and adjusting a heating power of the heating element, depending on the measured temperature.

15. The casting method according to claim 14, in which, when shooting, a density of the shot material can be measured and, depending on the measured density, the heating power of the heating element can be adjusted.

16. The casting method according to claim 14, in which, when shooting, the mould cavity is vented at different positions by means of a multi-channel mould venting system and a respective venting pressure of the mould cavity is measured at the different positions by air pressure sensors.

17. The casting method according to claim 16, in which, depending on at least one measurement signal from the air pressure sensors, an opening degree of at least one valve that is fluidically connected to one of the positions via an air line can be controlled.

18. The casting method according to claim 14, in which, after shooting and cooling the casting tool, a moulded casting arranged and formed in the mould cavity is ejected from the mould cavity by means of a mould ventilation system, for which purpose the mould ventilation system applies an air pressure to the casting via a valve block with multiple independently controllable valves, each of which is fluidically connected via an air line to one other position of the mould cavity.
